(19) United States
(12) Patent Application Publication
(10) Pub. No.: US 2025/0330034 A1
(43) Pub. Date: Oct. 23, 2025

(54) POWER SUPPLY CIRCUIT HAVING CURRENT CONTROL MECHANISM

(71) Applicant: ANPEC ELECTRONICS CORPORATION, HSINCHU (TW)

(72) Inventors: YI-CHUAN LU, HSINCHU (TW); CHIH-NING CHEN, TAIPEI CITY (TW); CHIH-HENG SU, Hsinchu City (TW)

(21) Appl. No.: 18/786,602

(22) Filed: Jul. 29, 2024

(30) Foreign Application Priority Data
Apr. 23, 2024 (TW) 113115031

(51) Int. Cl. H02J 7/00

(52) U.S. Cl. CPC H02J 7/00712; H02J 7/00304; H02J 7/0047; H02J 2207/10

(57) ABSTRACT

A power supply circuit having a current control mechanism is provided. The power supply circuit includes a charging driver, a plurality of input current processing circuits, a charging circuit and a control circuit. The charging driver includes a plurality of switch components and a driver circuit. The control circuit controls the plurality of input current processing circuits respectively to switch the plurality of switch components. At least one of a plurality of input currents that are supplied by a plurality of external input power sources flows to the driver circuit through at least one of the plurality of switch components. The driver circuit transmits the at least one of the plurality of input currents to the charging circuit, and drives the charging circuit to use the at least one of the plurality of input currents to charge an electronic device.

### CROSS-REFERENCE TO RELATED PATENT APPLICATION

This application claims the benefit of priority to Taiwan Patent Application No. 113115031, filed on Apr. 23, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power supply circuit, and more particularly to a power supply circuit having a current control mechanism.

### BACKGROUND OF THE DISCLOSURE

Power supply circuits are indispensable for electronic devices. The power supply circuits are used to adjust power and supply the adjusted power to the electronic devices. However, when the power supply circuit receives a plurality of input currents having different current values, an inappropriate amount of the input currents is obtained by the power supply circuit for charging the electronic device. As a result, the power supply circuit supplies excessive currents to the electronic device, causing unnecessary power consumption and even causing the electronic device to be damaged due to overcurrent.

### SUMMARY OF THE DISCLOSURE

In response to the above-referenced technical inadequacies, the present disclosure provides a power supply circuit having a current control mechanism. The power supply circuit includes a charging driver, a plurality of input current processing circuits, a charging circuit and a control circuit. The charging driver includes a plurality of switch components and a driver circuit. Each of the plurality of switch components has a first terminal, a second terminal and a control terminal. The first terminals of the plurality of switch components are respectively connected to a plurality of external input power sources. The external input power sources respectively supply a plurality of input currents. The driver circuit is connected to the second terminal of each of the plurality of switch components. The input current processing circuits are connected to the control terminal of each of the plurality of switch components and the plurality of external input power sources. The charging circuit is connected to the driver circuit and an electronic device. The control circuit is connected to the charging circuit and the plurality of input current processing circuits. The control circuit controls the plurality of input current processing circuits to switch the plurality of switch components such that at least one of the plurality of input currents flows to the driver circuit through at least one of the plurality of switch components. The driver circuit transmits the at least one of the plurality of input currents to the charging circuit, and drives the charging circuit to use the at least one of the plurality of input currents to charge the electronic device.

As described above, the present disclosure provides the power supply circuit having the current control mechanism. The control circuit of the power supply circuit of the present disclosure selects one of the plurality of input currents having different current values as the charging current of the electronic device (according to a control command stored in the control circuit or the driver circuit). If a pin of the power supply circuit of the present disclosure is connected to the external control parameter instructing circuit (including the one or more resistors), the power supply circuit of the present disclosure is capable of controlling the charging current of the electronic device and the current limiting circuit according to the external variable or fixed parameter. Therefore, even if the control command is not stored in the control circuit and the driver circuit and an integrated circuit package of the power supply circuit of the present disclosure does not have a plurality of pins, the power supply circuit of the present disclosure can directly control the charging current of the electronic device and the current limiting circuit according to the external control parameter without disassembling the integrated circuit package of the power supply circuit of the present disclosure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a power supply circuit having a current control mechanism according to a first embodiment of the present disclosure;

FIG. 2 is a circuit diagram of an external resistor included in an external control parameter instructing circuit connected to a power supply circuit having a current control mechanism according to a second embodiment of the present disclosure;

FIG. 3 is a circuit diagram of a plurality of external resistors and a plurality of external switching components that are included in an external control parameter instructing circuit connected to a power supply circuit having a current control mechanism according to a third embodiment of the present disclosure;

FIG. 4 is a block diagram of a power supply circuit having a current control mechanism according to a fourth embodiment of the present disclosure;

FIG. 5 is a block diagram of a power supply circuit having a current control mechanism according to a fifth embodiment of the present disclosure; and

FIG. 6 is a block diagram of one charge comparing circuit and a plurality of current switching comparing circuits that are included in a control circuit of a power supply circuit having a current control mechanism according to a sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

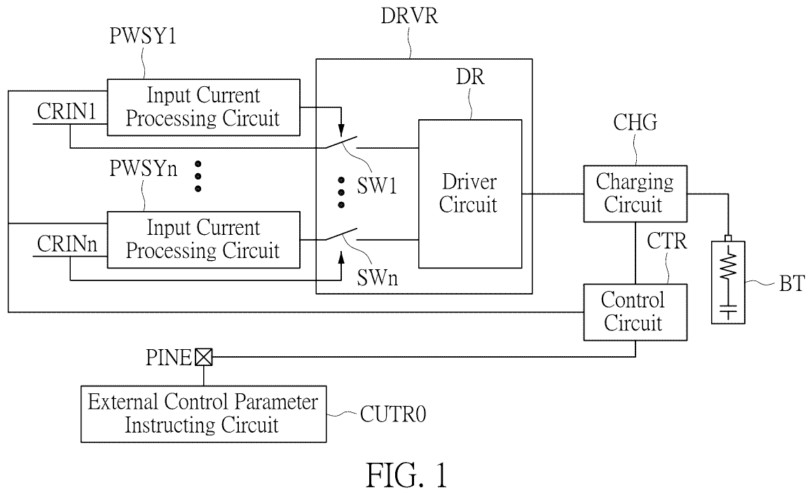

Reference is made to FIG. 1, which is a block diagram of a power supply circuit having a current control mechanism according to a first embodiment of the present disclosure.

As shown in FIG. 1, in the first embodiment, the power supply circuit of the present disclosure includes a charging driver DRVR, a plurality of input current processing circuits PWSY1 to PWSYn, a charging circuit CHG and a control circuit CTR. The charging driver DRVR includes a plurality of switch components SW1 to SWn and a driver circuit DR.

Each of the plurality of switch components SW1 to SWn has a first terminal, a second terminal and a control terminal.

The plurality of input current processing circuits PWSY1 to PWSYn are respectively connected to the control terminals of the plurality of switch components SW1 to SWn, and are connected to a plurality of external input power sources (not shown in figures). The plurality of input current processing circuits PWSY1 to PWSYn receive a plurality of input currents CRIN1 to CRINn as shown in FIG. 1 from the plurality of external input power sources. The input currents CRIN1 to CRINn have different current values.

The first terminals of the plurality of switch components SW1 to SWn are respectively connected to the plurality of external input power sources (not shown in figures).

The driver circuit DR is connected to the second terminal of each of the plurality of switch components SW1 to SWn.

The charging circuit CHG is connected to the driver circuit DR and an electronic device BT. For example, the electronic device BT described herein includes at least one battery, but the present disclosure is not limited thereto.

The control circuit CTR is connected to the charging circuit CHG and the plurality of input current processing circuits PWSY1 to PWSYn.

If the control circuit CTR is connected to an external control parameter instructing circuit CUTR0 through a pin PINE, the control circuit CTR may obtain an external control parameter from the external control parameter instructing circuit CUTR0 through the pin PINE. The external control parameter is equal to or represents a working current required for the electronic device BT (such as, but not limited to, the battery).

The control circuit CTR may determine the working current required for the electronic device BT according to the external control parameter from the external control parameter instructing circuit CUTR0. The control circuit CTR may select at least one of the plurality of input current processing circuits PWSY1 to PWSYn, and may turn on the at least one of the plurality of switch components SW1 to SWn. At least one of the plurality of input currents CRIN1 to CRINn that are supplied respectively by the plurality of external input power sources flows to the driver circuit DR through the at least one of the plurality of switch components SW1 to SWn that is turned on.

The driver circuit DR transmits the at least one of the plurality of input currents CRIN1 to CRINn to the charging circuit CHG, and drives the charging circuit CHG to use the least one of the plurality of input currents CRIN1 to CRINn to charge the electronic device BT.

A current value of a charging current supplied for charging the electronic device BT by the power supply circuit of the present disclosure depends on the external control parameter from the external control parameter instructing circuit CUTR0. The external control parameter may be a constant value or a variable value.

Therefore, if the control circuit CTR is connected to the external control parameter instructing circuit CUTR0 through the pin PINE, the current value of the charging current that is supplied for charging the electronic device BT by the power supply circuit of the present disclosure is easily modulated by changing the external control parameter without disposing additional circuit components inside the power supply circuit of the present disclosure. In addition, the driver circuit DR or the control circuit CTR of the power supply circuit of the present disclosure does not need to be removed and replaced with new circuit components, and codes or processes that are written in the driver circuit DR or the control circuit CTR do not need to be changed.

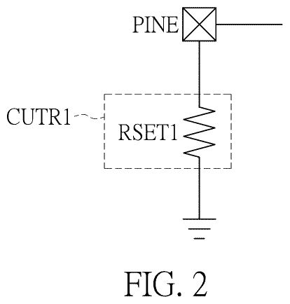

Reference is made to FIG. 2, which is a circuit diagram of an external resistor included in an external control parameter instructing circuit connected to the power supply circuit having the current control mechanism according to a second embodiment of the present disclosure.

The external control parameter instructing circuit CUTR0 connected to the control circuit CTR as shown in FIG. 1 may be replaced with an external control parameter instructing circuit CUTR1 as shown in FIG. 2. As shown in FIG. 2, the external control parameter instructing circuit CUTR1 includes an external resistor RSET1. The control circuit CTR as shown in FIG. 1 is connected to a first terminal of the external resistor RSET1 of the external control parameter instructing circuit CUTR1 through the pin PINE. A second terminal of the external resistor RSET1 is grounded.

The control circuit CTR may receive a voltage of the first terminal of the external resistor RSET1 as the external control parameter.

The control circuit CTR may determine the working current required for the electronic device BT according to the voltage of the first terminal of the external resistor RSET1. The control circuit CTR may, according to the working current required for the electronic device BT, determine which one or more of the plurality of input currents CRIN1 to CRINn to select to output a plurality of input supply controlling signals respectively to the plurality of input current processing circuits PWSY1 to PWSYn.

Then, the input current processing circuits PWSY1 to PWSYn switch the switch components SW1 to SWn according to the input supply controlling signals from the control circuit CTR, respectively. As a result, at least one of the plurality of input currents CRIN1 to CRINn that are supplied respectively by the plurality of external input power sources flows to the driver circuit DR through at least one of the plurality of switch components SW1 to SWn.

The driver circuit DR transmits the at least one of the plurality of input currents CRIN1 to CRINn to the charging circuit CHG, and drives the charging circuit CHG to charge the electronic device BT.

The current value of the charging current that is supplied for charging the electronic device BT by the power supply circuit of the present disclosure may depend on the voltage of the external resistor RSET1.

In practice, the first terminal of the external resistor RSET1 may be connected to an external power supply circuit (not shown in figures). Under this condition, a voltage or a current received by the external power supply circuit may be easily modulated to change the voltage of the external resistor RSET so as to adjust the current value of the charging current that is supplied to the electronic device BT by the power supply circuit of the present disclosure.

As shown in FIG. 2, the external resistor RSET1 is a fixed resistor having a constant resistance. In practice, the external resistor RSET1 may be replaced with a variable resistor. If the external resistor RSET1 is the variable resistor, a resistance of the external resistor RSET1 may be changed to adjust the voltage of the external resistor RSET1 so as to adjust the current value of the charging current that is supplied to the electronic device BT by the power supply circuit of the present disclosure.

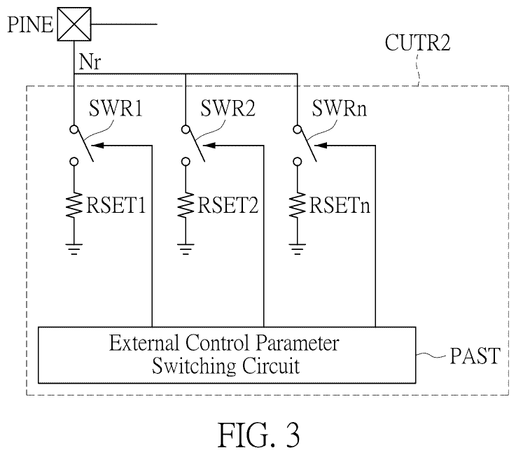

Reference is made to FIG. 3, which is a circuit diagram of a plurality of external resistors and a plurality of external switching components that are included in an external control parameter instructing circuit connected to the power supply circuit having the current control mechanism according to a third embodiment of the present disclosure.

The external control parameter instructing circuit CUTR0 connected to the control circuit CTR of the power supply circuit as shown in FIG. 1 may be replaced with an external control parameter instructing circuit CUTR2 as shown in FIG. 3.

As shown in FIG. 3, the external control parameter instructing circuit CUTR2 includes a plurality of external switching components SWR1 to SWRn, a plurality of external resistors RSET1 to RSETn and an external control parameter switching circuit PAST.

The number of the plurality of external switching components SWR1 to SWRn, and the number and resistances of the external resistors RSET1 to RSETn, may be determined according to actual requirements, but the present disclosure is not limited thereto.

Each of the plurality of external switching components SWR1 to SWRn has a first terminal, a second terminal and a control terminal. Each of the plurality of external resistors RSET1 to RSETn has a first terminal and a second terminal.

The first terminal of each of the plurality of external switching components SWR1 to SWRn is connected to the control circuit CTR.

The second terminals of the plurality of external switching components SWR1 to SWRn are respectively connected to the first terminals of the plurality of external resistors RSET1 to RSETn. The second terminals of the plurality of external resistors RSET1 to RSETn are grounded.

The control terminal of each of the plurality of external switching components SWR1 to SWRn is connected to the external control parameter switching circuit PAST. The external control parameter switching circuit PAST determines a parameter (such as a voltage or a resistance) corresponding to the working current required for the electronic device BT (such as, but not limited to, the battery). The external control parameter switching circuit PAST, according to the parameter, selects at least one of the plurality of external resistors RSET1 to RSETn and turns on the at least one of the plurality of external switching components SWR1 to SWRn.

When the at least one of the plurality of external switching components SWR1 to SWRn is turned on, the control circuit CTR receives a parameter (such as a voltage or a current) of a node Nr as the external control parameter through the pin PINE. Then, the control circuit CTR may, according to the external control parameter, determine the working current required for the electronic device BT to output the plurality of input supply controlling signals respectively to the plurality of input current processing circuits PWSY1 to PWSYn.

Then, the input current processing circuits PWSY1 to PWSYn switch the switch components SW1 to SWn according to the input supply controlling signals from the control circuit CTR, respectively. As a result, at least one of the plurality of input currents CRIN1 to CRINn that are supplied respectively by the plurality of external input power sources flows to the driver circuit DR through the at least one of the plurality of external switching components SWR1 to SWRn.

The driver circuit DR transmits the at least one of the plurality of input currents CRIN1 to CRINn from the plurality of external input power sources to the charging circuit CHG, and drives the charging circuit CHG to charge the electronic device BT.

Therefore, the external control parameter switching circuit PAST may selectively turn on the plurality of switch components SW1 to SWn to selectively set the external control parameter of the node Nr that is received by the control circuit CTR through the pin PINE. The current value of the charging current that is supplied to the electronic device BT by the power supply circuit of the present disclosure is selectively controlled by selectively setting the external control parameter of the node Nr.

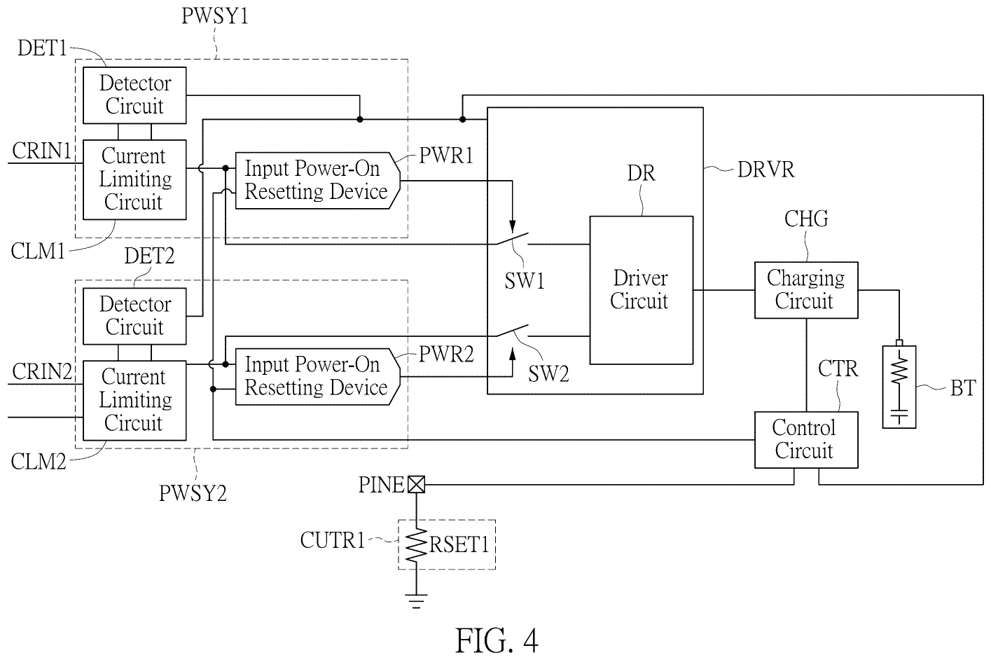

Reference is made to FIG. 4, which is a block diagram of a power supply circuit having a current control mechanism according to a fourth embodiment of the present disclosure.

The power supply circuit of the present disclosure includes two input current processing circuits PWSY1, PWSY2 as shown in FIG. 4. In practice, the power supply circuit of the present disclosure may include more input current processing circuits.

In other words, each of the plurality of input current processing circuits PWSY1 to PWSYn of the power supply circuit of the present disclosure as shown in FIG. 1 may be the same as the input current processing circuits PWSY1 or PWSY2 as shown in FIG. 4.

As shown in FIG. 4, the input current processing circuit PWSY1 includes a current limiting circuit CLM1, a detector circuit DET1 and an input power-on resetting device PWR1. Similarly, the input current processing circuit PWSY2 includes a current limiting circuit CLM2, a detector circuit DET2 and an input power-on resetting device PWR2.

The current limiting circuit CLM1 is connected to the external input power source (not shown in figures). The current limiting circuit CLM1 receives the input current CRIN1 from the external input power source. The external input power source may be an adapter or USB, but the present disclosure is not limited thereto. The current limiting circuit CLM2 is connected to the external input power source (not shown in figures). The current limiting circuit CLM2 receives the input current CRIN2 from the external input power source.

The detector circuit DET1 of the input current processing circuit PWSY1 is connected to the current limiting circuit CLM1 and the control circuit CTR. Similarly, the detector circuit DET2 of the input current processing circuit PWSY2 is connected to the current limiting circuit CLM2 and the control circuit CTR.

The input power-on resetting device PWR1 of the input current processing circuit PWSY1 is connected to the current limiting circuit CLM1, and is connected to the control terminal of the switch component SW1 of the charging driver DRVR. Similarly, the input power-on resetting device PWR2 of the input current processing circuit PWSY2 is connected to the current limiting circuit CLM2, and is connected to the control terminal of the switch component SW2 of the charging driver DRVR.

The control circuit CTR receives the voltage of the external resistor RSET1 of the external control parameter instructing circuit CUTR1 as the external control parameter, and outputs a control parameter instructing signal according to the voltage of the external resistor RSET1.

The detector circuit DET1 of the input current processing circuit PWSY1 and the detector circuit DET2 of the input current processing circuit PWSY2 detect the control parameter instructing signal outputted by the control circuit CTR.

The current limiting circuit CLM1 determines the external control parameter (that is the voltage of the external resistor RSET1) instructed by the control parameter instructing signal detected by the detector circuit DET1. The current limiting circuit CLM2 determines the external control parameter (that is the voltage of the external resistor RSET1) instructed by the control parameter instructing signal detected by the detector circuit DET2. The current limiting circuit CLM1 and the current limiting circuit CLM2 determine a specific current value corresponding to the external control parameter, and further set a current limit value according to the specific current. The specific current value may be a value of the working current of the electronic device BT. The current limit value is a maximum current value that the electronic device BT can withstand.

In addition, the detector circuit DET1 of the input current processing circuit PWSY1 may detect the input current CRIN1 that is received from the external input power source by the current limiting circuit CLM1 to output a detected signal to the current limiting circuit CLM1. Similarly, the detector circuit DET2 of the input current processing circuit PWSY2 may detect the input current CRIN2 that is received from the external input power source by the current limiting circuit CLM2 to output a detected signal to the current limiting circuit CLM2.

When the detector circuit DET1 of the input current processing circuit PWSY1 detects and determines that the input current CRIN1 received by the current limiting circuit CLM1 is larger than the current limit value, the current limiting circuit CLM1 of the input current processing circuit PWSY1 controls the input current processing circuit PWSY1 to continually turn off the switch component SW1 or to short an on-time of the switch component SW1 to fall within an on-time limit value.

Conversely, when the detector circuit DET1 of the input current processing circuit PWSY1 detects and determines that the input current CRIN1 received by the current limiting circuit CLM1 is not larger than the current limit value, the current limiting circuit CLM1 of the input current processing circuit PWSY1 controls the input current processing circuit PWSY1 to turn on the switch component SW1.

Similarly, when the detector circuit DET1 of the input current processing circuit PWSY1 detects and determines that the input current CRIN1 received by the current limiting circuit CLM1 is larger than the current limit value, the current limiting circuit CLM2 of the input current processing circuit PWSY2 controls the input current processing circuit PWSY2 to continually turn off the switch component SW2 or to short an on-time of the switch component SW2 to fall within the on-time limit value.

Conversely, when the detector circuit DET2 of the input current processing circuit PWSY2 detects and determines that the input current CRIN2 received by the current limiting circuit CLM2 is not larger than the current limit value, the current limiting circuit CLM2 of the input current processing circuit PWSY2 controls the input current processing circuit PWSY2 to turn on the switch component SW2.

It is worth noting that, the input current CRIN1 received by the current limiting circuit CLM1 of the input current processing circuit PWSY1 is not equal to the input current CRIN2 received by the current limiting circuit CLM2 of the input current processing circuit PWSY2.

For example, one of the input current CRIN1 of the input current processing circuit PWSY1 and the input current CRIN2 of the input current processing circuit PWSY2 is larger than a current threshold, and the other of the input current CRIN1 and the input current CRIN2 is smaller than the current threshold.

That is, a user may, according to the working current value of the electronic device BT, set the resistance of the external resistor RSET1 of the external control parameter instructing circuit CUTR1 outside the power supply circuit so as to set the external control parameter (that is the voltage of the external resistor RSET1). The power supply circuit of the present disclosure, according to the external control parameter, selects one of the plurality of input currents CRIN1 and CRIN2 as the charging current of the electronic device BT. For example, the power supply circuit of the present disclosure selects one of the input current CRIN1 having a small current value and the input current CRIN2 having a large current value as the charging current of the electronic device BT.

For example, when the resistance of the external resistor RSET1 falls within a range of 8 k to 120 kΩ and the current limit value is set to 100 mA, the charging current of the electronic device BT falls within a range of 20 mA to 100 mA. Alternatively, when the resistance of the external resistor RSET1 falls within a range of 120 k to 240 kΩ and the current limit value is set to 200 mA, the charging current of the electronic device BT falls within a range of 100 mA to 200 mA.

In practice, the external control parameter instructing circuit CUTR1 as shown in FIG. 4 may be replaced with a variable resistor or the external control parameter instructing circuit CUTR2 as shown in FIG. 3.

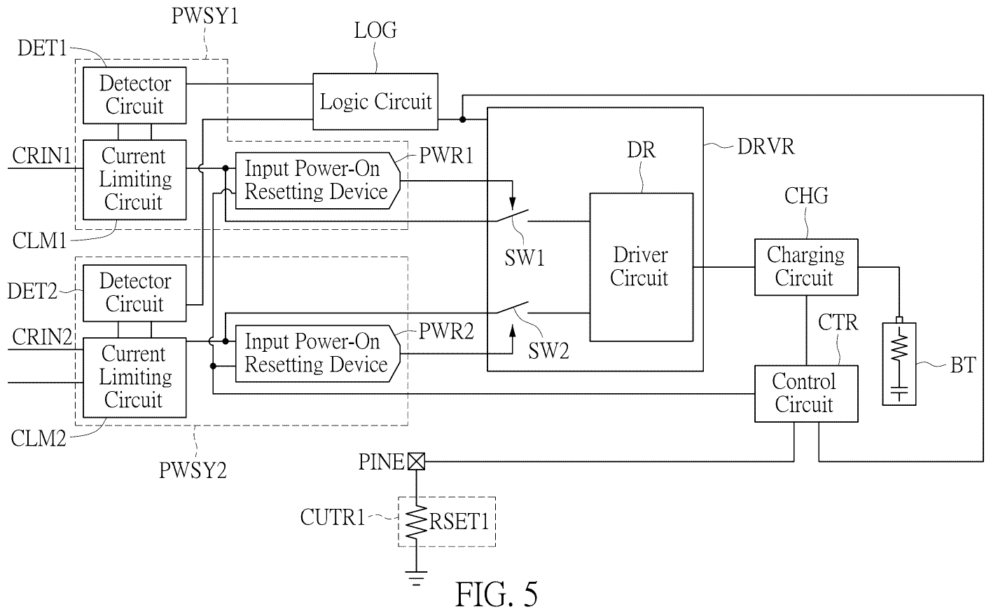

Reference is made to FIG. 5, which is a block diagram of a power supply circuit having a current control mechanism according to a fifth embodiment of the present disclosure. The same descriptions of the power supply circuit shown in FIG. 5 that are the same as the power supply circuit shown in FIG. 4 are not repeated herein.

A difference between the power supply circuit shown in FIG. 5 and the power supply circuit shown in FIG. 4 is that, the power supply circuit shown in FIG. 5 further includes a logic circuit LOG.

As shown in FIG. 5, the logic circuit LOG is connected between the control circuit CTR and the detector circuit DET1 of the input current processing circuit PWSY1, and is connected between the control circuit CTR and the detector circuit DET2 of the input current processing circuit PWSY2.

After the control circuit CTR outputs the control parameter detected signal according to the voltage of the external resistor RSET1, the logic circuit LOG outputs a logic signal according to the control parameter instructing signal from the control circuit CTR.

The detector circuit DET1 of the input current processing circuit PWSY1 and the detector circuit DET2 of the input current processing circuit PWSY2 detect the logic signal outputted by the logic circuit LOG.

The current limiting circuit CLM1 of the input current processing circuit PWSY1 sets the current limit value according to the logic signal detected by the detector circuit DET1. Similarly, the current limiting circuit CLM2 of the input current processing circuit PWSY2 sets the current limit value according to the logic signal detected by the detector circuit DET2.

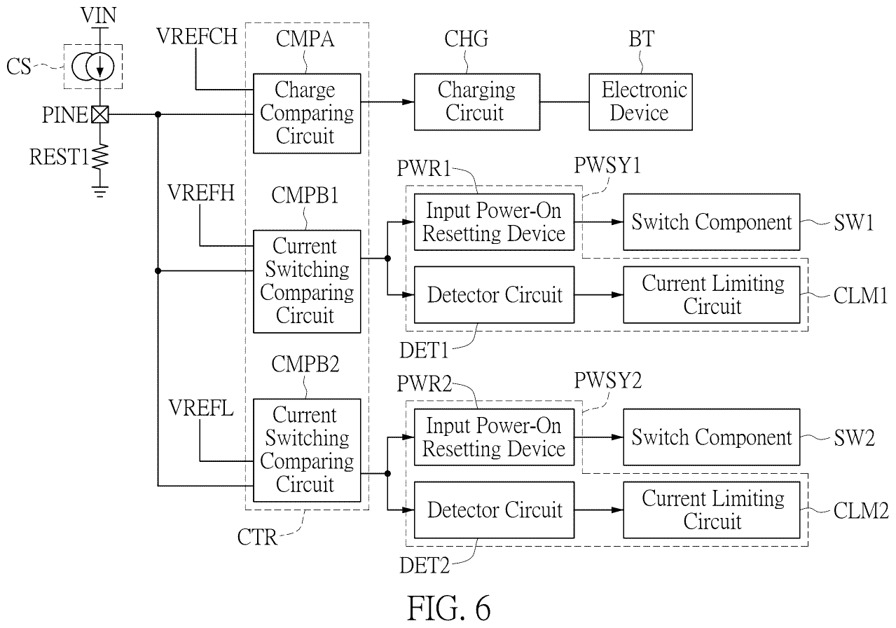

Reference is made to FIG. 6, which is a block diagram of one charge comparing circuit and a plurality of current switching comparing circuits that are included in a control circuit of the power supply circuit having the current control mechanism according to a sixth embodiment of the present disclosure.

The control circuit of the power supply circuit of the present disclosure such as, but not limited to, the control circuit CTR the power supply circuit shown in FIG. 4, may include current switching comparing circuits CMPB1, CMPB2 and a charge comparing circuit CMPA as shown in FIG. 6.

The power supply circuit includes input current processing circuits PWSY1 and PWSY2 as shown in FIG. 6, and the control circuit CTR of the power supply circuit correspondingly includes two current switching comparing circuits CMPB1, CMPB2, but the present disclosure is not limited thereto. The number of the current switching comparing circuits included in the control circuit of the power supply circuit of the present disclosure may be adjusted with a change in the number of the input current processing circuits.

As shown in FIG. 6, the current switching comparing circuits CMPB1, CMPB2 are connected to the first terminal of the external resistor RSET1 of the external control parameter instructing circuit CUTR1 through the pin PINE. The second terminal of the external resistor RSET1 is grounded.

The first terminal of the external resistor RSET1 is connected to an output terminal of an external input power source CS (such as, but not limited to, a current mirror), a second input terminal of each of the current switching comparing circuits CMPB1, CMPB2 of the control circuit CTR and a second input terminal of the charge comparing circuit CMPA. An input terminal of the external input power source CS may be connected to an input voltage VIN.

In practice, the external resistor RSET1 as shown in FIG. 6 may be replaced with a variable resistor. Alternatively, the external resistor RSET1 may be replaced with the plurality of external switching components SWR1 to SWRn, the plurality of external resistors RSET1 to RSETn and the external control parameter switching circuit PAST of the external control parameter instructing circuit CUTR2 as shown in FIG. 3.

As shown in FIG. 6, an output terminal of the charge comparing circuit CMPA of the control circuit CTR is connected to the charging circuit CHG, and the charging circuit CHG is connected to the electronic device BT. The current switching comparing circuits CMPB1 of the control circuit CTR is connected to the input power-on resetting device PWR1 and the detector circuit DET1 of the input current processing circuit PWSY1. The current switching comparing circuit CMPB2 of the control circuit CTR is connected to the input power-on resetting device PWR2 and the detector circuit DET2 of the input current processing circuit PWSY2.

The external input power source CS (such as, but not limited to, the current mirror) supplies an external current to the external resistor RSET1 of the external control parameter instructing circuit CUTR1 such that the voltage of the first terminal of the external resistor RSET1 increases.

The second input terminal of each of the current switching comparing circuits CMPB1, CMPB2 of the control circuit CTR and the second input terminal of the charge comparing circuit CMPA receive the voltage of the first terminal of the external resistor RSET1 as the external control parameter.

The charge comparing circuit CMPA of the control circuit CTR compares the voltage of the first terminal of the external resistor RSET1 (that is the external control parameter) of the external control parameter instructing circuit CUTR1 with a charge reference parameter VREFCH such as a charge reference voltage to output a charge comparing signal. The charging circuit CHG may charge the electronic device BT according to the charge comparing signal from the charge comparing circuit CMPA.

In addition, the current switching comparing circuit CMPB1 of the control circuit CTR may compare the voltage of the first terminal of the external resistor RSET1 (that is the external control parameter) of the external control parameter instructing circuit CUTR1 with a switching reference parameter such as a switching threshold voltage VREFH to output a current switching instructing signal to the input current processing circuit PWSY1.

Similarly, the current switching comparing circuit CMPB2 of the control circuit CTR may compare the voltage of the first terminal of the external resistor RSET1 (that is the external control parameter) of the external control parameter instructing circuit CUTR1 with a switching reference parameter such as a switching threshold voltage VREFL to output a current switching instructing signal to the input current processing circuit PWSY2.

It is worth mentioning that, the switching threshold voltage VREFH is different from the switching threshold voltage VREFL such that the current switching instructing signal outputted by the external control parameter instructing circuit CUTR1 is different from the current switching instructing signal outputted by the external control parameter instructing circuit CUTR2. As a result, one of the switch components SW1 and SW2 is selectively turned on so as to select one of the input currents CRIN1, CRIN2 as the charging current of the electronic device BT.

That is, the user may, according to the working current value of the electronic device BT, set the resistance of the external resistor RSET1 of the external control parameter instructing circuit CUTR1 outside the power supply circuit or set the current value of the external current that is supplied to the external resistor RSET1 by the external input power source CS (such as, but not limited to, the current mirror) so as to set the voltage of the external resistor RSET1. The power supply circuit of the present disclosure selects one of the input currents CRIN1, CRIN2 as the charging current of the electronic device BT according to the voltage of the external resistor RSET1.

In practice, the logic circuit LOG shown in FIG. 5 may also be connected between the current switching comparing circuit CMPB1 and the detector circuit DET1 and between the current switching comparing circuit CMPB2 and the detector circuit DET2 as shown in FIG. 6.

In conclusion, the present disclosure provides the power supply circuit having the current control mechanism. The control circuit of the power supply circuit of the present disclosure selects one of the plurality of input currents having different current values as the charging current of the electronic device (according to a control command stored in the control circuit or the driver circuit). If the pin of the power supply circuit of the present disclosure is connected to the external control parameter instructing circuit (including the one or more resistors), the power supply circuit of the present disclosure is capable of controlling the charging current of the electronic device and the current limiting circuit according to the external variable or fixed parameter. Therefore, even if the control command is not stored in the control circuit and the driver circuit and an integrated circuit package of the power supply circuit of the present disclosure does not have a plurality of pins, the power supply circuit of the present disclosure can directly control the charging current of the electronic device and the current limiting circuit according to the external control parameter without disassembling the integrated circuit package of the power supply circuit of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power supply circuit having a current control mechanism, comprising:
a charging driver including:
a plurality of switch components each having a first terminal, a second terminal and a control terminal, wherein the first terminals of the plurality of switch components are respectively connected to a plurality of external input power sources, and the plurality of external input power sources respectively supply a plurality of input currents; and
a driver circuit connected to the second terminal of each of the plurality of switch components;
a plurality of input current processing circuits connected to the control terminal of each of the plurality of switch components and the plurality of external input power sources;
a charging circuit connected to the driver circuit and an electronic device; and
a control circuit connected to the charging circuit and the plurality of input current processing circuits;
wherein the control circuit controls the plurality of input current processing circuits to switch the plurality of switch components such that at least one of the plurality of input currents flows to the driver circuit through at least one of the plurality of switch components, and the driver circuit transmits the at least one of the plurality of input currents to the charging circuit and drives the charging circuit to use the at least one of the plurality of input currents to charge the electronic device.

2. The power supply circuit according to claim 1, wherein the electronic device includes at least one battery.

3. The power supply circuit according to claim 1, wherein the input current supplied by one of the plurality of external input power sources is larger than a current threshold, and the input current supplied by another one of the plurality of external input power sources is smaller than the current threshold.

4. The power supply circuit according to claim 1, wherein the control circuit is connected to an external control parameter instructing circuit through a pin, and the external control parameter instructing circuit instructs the control circuit to control the plurality of input current processing circuits.

5. The power supply circuit according to claim 4, wherein the external control parameter instructing circuit includes an external resistor, a first terminal of the external resistor is connected to the control circuit, and a second terminal of the external resistor is grounded.

6. The power supply circuit according to claim 4, wherein the external control parameter instructing circuit includes a plurality of external switching components and a plurality of external resistors, each of the plurality of external switching components has a first terminal and a second terminal, and each of the plurality of external resistors has a first terminal, a second terminal and a control terminal;
wherein the control terminal of each of the plurality of external switching components is connected to an external switching control circuit, the first terminal of each of the plurality of external switching components is connected to the control circuit, the second terminals of the plurality of external switching components are respectively connected to the first terminals of the plurality of external resistors, the second terminal of each of the plurality of external resistors is grounded, and the external control parameter instructing circuit selectively turns on the plurality of switch components.

7. The power supply circuit according to claim 4, wherein the control circuit, according to an external control parameter from the external control parameter instructing circuit, controls at least one of the plurality of input current processing circuits to turn on at least one of the plurality of switch components, such that at least one of the plurality of input currents flows to the driver circuit through the at least one of the switch components.

8. The power supply circuit according to claim 4, wherein the control circuit outputs a control parameter instructing signal to each of the plurality of input current processing circuits according to an external control parameter from the external control parameter instructing circuit, each of the plurality of input current processing circuits determines a specific current value corresponding to the external control parameter instructed by the control parameter instructing signal, each of the plurality of input current processing circuits selects at least one of the plurality of switch components according to the specific current value, and each of the plurality of input current processing circuits turns on the at least one of the plurality of switch components.

9. The power supply circuit according to claim 8, wherein, when the input current that is received from the external input power source by each of the plurality of input current processing circuits is larger than the specific current value, each of the plurality of input current processing circuits continually turns off the switch component connected thereto or controls time within which the switch component is turned on to fall within an on-time limit value.

10. The power supply circuit according to claim 1, wherein the control circuit includes:
a plurality of current switching comparing circuits connected to an external control parameter instructing circuit, and configured to compare an external control parameter from the external control parameter instructing circuit respectively with a plurality of switching reference parameters to output a plurality of current switching instructing signals respectively to the plurality of input current processing circuits;
wherein each of the plurality of input current processing circuits switches the switch component connected thereto according to the current switching instructing signal from the control circuit.

11. The power supply circuit according to claim 10, wherein the control circuit further includes:
a charge comparing circuit connected to the external control parameter instructing circuit, wherein the charge comparing circuit compares the external control parameter from the external control parameter instructing circuit with a charge reference parameter to output a charge comparing signal, and the charging circuit charges the electronic device according to the charge comparing signal from the charge comparing circuit.

12. The power supply circuit according to claim 11, wherein the external control parameter instructing circuit includes an external resistor, a first terminal of the external resistor is connected to an external power supply circuit, each of the plurality of current switching comparing circuits and the charge comparing circuit, a second terminal of the external resistor is grounded, the external resistor receives power from the external power supply circuit, and the plurality of current switching comparing circuits and the charge comparing circuit use a voltage of the first terminal of the external resistor as the external control parameter.

13. The power supply circuit according to claim 12, wherein the external power supply circuit includes a current mirror.

14. The power supply circuit according to claim 8, wherein the external control parameter instructing circuit includes an external resistor, a first terminal of the external resistor is connected to the control circuit, and the second terminal of the external resistor is grounded.

15. The power supply circuit according to claim 14, wherein the external resistor is a variable resistor.

16. The power supply circuit according to claim 8, wherein the external control parameter instructing circuit includes a plurality of external switching components and a plurality of external resistors, each of the plurality of external switching components has a first terminal and a second terminal, and each of the plurality of external resistors has a first terminal, a second terminal and a control terminal;
wherein the control terminal of each of the plurality of external switching components is connected to an external switching control circuit, the first terminal of each of the plurality of external switching components is connected to the control circuit, the second terminals of the plurality of external switching components are respectively connected to the first terminals of the plurality of external resistors, the second terminal of each of the plurality of external resistors is grounded, and the external control parameter instructing circuit selectively turns on the plurality of external switching components.

17. The power supply circuit according to claim 1, wherein each of the plurality of input current processing circuits includes:
an input power-on resetting device connected to the control terminal of one of the plurality of switch components;
a detector circuit connected to the control circuit, and configured to detect a control parameter instructing signal outputted by the control circuit to output a control parameter detected signal;
a current limiting circuit connected to the input power-on resetting device, the detector circuit, one of the plurality of external input power sources, and the first terminal of one of the plurality of switch components, wherein the current limiting circuit is configured to set a current limit value according to the control parameter detected signal from the detector circuit; and
wherein, when the detector circuit determines that the input current is not larger than the current limit value, the current limiting circuit controls the input power-on resetting device to turn on the one of the plurality of switch components and transmits the input current from the one of the plurality of external input power sources through the one of the plurality of switch components.

18. The power supply circuit according to claim 17, wherein, when the input current received by the current limiting circuit is larger than the current limit value, the current limiting circuit controls the input power-on resetting device to turn off the switch component connected thereto.

19. The power supply circuit according to claim 17, further comprising:
a logic circuit connected between the control circuit and the detector circuit of each of the plurality of input current processing circuits, wherein the logic circuit is configured to output a logic signal according to the control parameter instructing signal from the control circuit, and the current limiting circuit sets the current limit value according to the logic signal detected by the detector circuit.

20. The power supply circuit according to claim 1, wherein the control circuit, according to a working current value of the electronic device, controls one of the plurality of input current processing circuits to turn on the switch component connected thereto such that one of the plurality of input currents flows to the driver circuit through the switch component being turned on.
